(19) United States
(12) Patent Application Publication
(10) Pub. No.: US 2026/0168884 A1
(43) Pub. Date: Jun. 18, 2026

(54) PHOTONIC WAFER WITH TEST DEVICE

(71) Applicant: COMMISSARIAT À L'ENERGIE ATOMIQUE ET AUX ENERGIES ALTERNATIVES, PARIS (FR)

(72) Inventors: Emanuel PEINKE, GRENOBLE (FR); Sylvain GUERBER, Grenoble (FR); Karim HASSAN, GRENOBLE (FR)

(21) Appl. No.: 19/401,269

(22) Filed: Nov. 25, 2025

(30) Foreign Application Priority Data
Dec. 16, 2024 (FR) 2414231

(51) Int. Cl. G01M 11/00; G02B 6/12; G02B 6/122

(52) U.S. Cl. CPC G01M 11/30; G02B 6/1228; G02B 2006/12038; G02B 2006/12061; G02B 2006/12107; G02B 2006/12147

(57) ABSTRACT

A photonic wafer includes at least one pattern, a pattern including at least one photonic chip, referred to as a functional photonic chip, and a test device, the test device includes a first test assembly including: a first test edge coupler, called a first test coupler, a first test light/guide coupling device, a second test edge coupler, called a second test coupler, a second test light/guide coupling device, the first and second test coupler being arranged symmetrically about a point O, an assembly, referred to as a reference assembly, including a reference waveguide and a first and second reference light/guide coupling device, the first and second test light/guide coupling devices and the first and second reference light/guide coupling devices all being identical.

### CROSS-REFERENCE TO RELATED APPLICATION

This application claims priority to foreign French patent application No. FR 2414231, filed on Dec. 16, 2024, the disclosure of which is incorporated by reference in its entirety.

### FIELD OF THE INVENTION

The field of the invention is silicon photonics, used for example for telecommunications. The invention relates to photonic wafers comprising a set of photonic chips in which photonic circuits are integrated, and to the characterization thereof. The invention relates more particularly to the characterization of edge couplers allowing light to be injected into the circuit and/or to be recovered at the output of the circuit.

### BACKGROUND

In the context of data centers, high-performance computing or 5G, silicon photonics is essential in order to have very high-rate data flows, and the demand for data rate is only increasing.

Any photonic solution requires it to be integrated with other optical and/or electronic components. At the optical level, a photonic wafer or chip comprises a substrate Sub defining an XY plane on which a cladding layer CL is arranged. Waveguides, configured to guide light, are integrated inside this layer CL. The guides extend in the XY plane.

One example of an optical interface is the fiber-chip interface. These fiber/chip interfaces optically connect photonic chips (typically waveguides) to optical fibers in order to send signals into communication networks and to receive signals therefrom. Various types of couplers are used to form the fiber/chip interface.

A first type of coupler is the grating coupler (GC), which achieves what is referred to as vertical coupling via the surface of the chip.

A second type of coupler is the edge coupler, called an EDC or spot converter (spot size converter, SSC) in the field. The use of EDCs makes it possible to limit the optical losses of the interface. In the context of optical telecommunications, reducing optical losses makes it possible, inter alia, to increase communication distances and/or bandwidth, or to reduce the energy consumption of optical systems. All three provide a commercial advantage. With regard to quantum photonics applications, these are highly dependent on the absence of losses, and many applications are possible only with very low losses in the overall optical system.

There are many types of EDCs and fibers, which are often optimized so as to improve certain performance. The publication by Riccardo Marchetti, et al., “Coupling strategies for silicon photonics integrated chips [invited],” Photon. Res. 7, 201-239 (2019) gives a good overview and explains strategies for assembling these in its last chapter “6. PACKAGING TECHNIQUES”.

Typically, an EDC consists of a waveguide portion WG0 and an end EXT0 configured to match the optical mode propagating in the guide to the mode of the optical fiber to which it is coupled. By way of example, the cross section of a waveguide is typically less than 1 μm (200-900 nm), whereas the core of an optical fiber has a diameter of at least 5 μm. One example of an EDC that is widely used in practice are “tapers”, having an end the cross section of which gradually decreases, thereby making it possible to spread the mode to match it to the fiber. However, there are many other types of EDC, with various shapes and structures (see for example the Marchetti publication cited above).

Edge coupling between an EDC and a fiber is achieved by digging a trench TR into the photonic wafer, as illustrated in FIG. 1. The wafer may then possibly be sliced at the trench TR in order to make the facet FC more accessible. A small cladding layer thickness has been retained here between the end of the EDC EXT0 and the facet FC created by the trench TR and allowing coupling with the fiber.

In practice, it is difficult to achieve low-loss EDC-fiber coupling. The system is highly sensitive to the slightest misalignment, whether in terms of translation or in terms of angle. The conditions for perfect coupling are difficult to achieve. For perfect coupling, the light beams guided by the fiber and by the EDC must be identical and ideally perfectly superimposed (that is to say the respective modes overlap), that is to say their shape, mode size, propagation axis, as well as the wavefront that locally describes the phase of the light, must be identical and perfectly superimposed (overlap of the respective modes).

Losses measured during EDC-fiber coupling consist of losses related to imperfect coupling, losses intrinsically related to the EDC, and other losses. The losses measured during EDC-fiber coupling are therefore the sum of losses due to: (i) partial overlap between the modes of the fiber and of the EDC (poor design and/or misalignment between the fiber and the EDC), (ii) propagation losses in the EDC (intrinsic losses), and (iii) the interfaces between the fiber and the chip (reflections).

To test the performance of an EDC-fiber coupling, one approach that is widely applied by the community is the use of a characterization bench, illustrated in FIG. 2. This bench comprises two EDCs connected via the waveguide portion, each end EXT1, EXT2 being coupled to an associated fiber FO1, FO2, respectively. Nanopositioners make it possible to align the fibers in relation to the EDCs, and a microscope makes it possible to visualize the alignment. The losses are typically measured by calculating the ratio of an intensity Iₒᵤₜ at the output of one of the fibers (FO2) and an intensity Iᵢₙ injected into the other fiber (FO1). These losses, which are often expressed on a logarithmic scale, correspond to those of the complete fiber-EDC plus waveguide plus EDC-fiber system.

Document WO 2020/132968 describes a test method with EDCs, and how to connect a strip of fibers (110, 150) to the EDCs (111, 151) of a photonic structure 140 of a photonic chip, as illustrated in FIG. 3. This method has the particular feature of being able to test the optical components of the photonic chip at the scale of an entire wafer, including the EDCs. The use of this method makes it possible to test an assembly consisting of EDCs, fibers and photonic structures, but does not provide any information about the EDC alone.

Indeed, in the majority of test systems, such as in the one in FIG. 1, the result is influenced by numerous factors that worsen the accuracy of the measurement. There may be an angular and/or translational misalignment, which may be amplified by vibrations often coming from the outside. Alignment is delicate and highly sensitive. The optical fiber itself contributes to losses. Uncertainties related to its fabrication (mode size that may vary, condition of the surface of the fiber, etc.) impact the measurement. In a commercial circuit, the fibers might be glued to the chip, thereby also creating uncertainties during the test (condition of the glue, etc.) and making the test destructive, because gluing is required in order to carry out the measurement. In the case of optical fibers without a lens, the nominal working distance is equal to zero. In this condition, the fiber and the EDC should touch one another. This is not conceivable in practice because of the risk of damaging the EDC or the fiber. The medium between the fiber and the chip has an equal impact on the performance of the EDC.

These various methods thus have the drawback of measuring only total losses, whereas it would be beneficial to characterize the various elements separately, and more particularly to measure the intrinsic losses of the EDC independently.

### SUMMARY OF THE INVENTION

One aim of the present invention is to rectify the abovementioned drawbacks by proposing a photonic wafer integrating a test circuit that makes it possible to measure intrinsic losses of the EDCs of the wafer.

The present invention relates to a photonic wafer comprising at least one pattern, a pattern comprising at least one photonic chip, referred to as a functional photonic chip, and a test device, a functional photonic chip comprising photonic circuits comprising at least one functional edge coupler and functional waveguides, the photonic wafer comprising a substrate in an XY plane, a cladding layer and waveguides integrated into said cladding layer,
the test device comprising:
   a first test assembly comprising:
      a first test edge coupler, called a first test coupler, comprising a first test waveguide and a first end,
      a first test light/guide coupling device,
      a second test edge coupler, called a second test coupler, comprising a second test waveguide and a second end,
      a second test light/guide coupling device,
      the first and second test coupler being identical,
      the first and second test coupler being arranged symmetrically about a point O, the first and second end facing one another and being separated by a first non-zero separation distance,
   an assembly, referred to as a reference assembly, comprising a reference waveguide and a first and second reference light/guide coupling device,
   the first and second test light/guide coupling devices and the first and second reference light/guide coupling devices all being identical.

According to one embodiment, the functional chip extends over what is referred to as a functional area, and the test device is arranged outside said functional area.

According to one embodiment, the first separation distance is equal to twice a nominal distance between one end of a functional edge coupler and an optical fiber with which said functional edge coupler is associated.

According to one variant, a trench has been etched in a separation area between the first end and the second end.

According to one embodiment, the trench is filled with an element chosen from a solid material, a liquid, a gas or a vacuum.

According to one embodiment, the substrate is made of silicon, the cladding layer is made of silicon oxide and the waveguides are made of silicon or silicon nitride.

According to one embodiment, the test device furthermore comprises at least one second test assembly having a second separation distance different from the first separation distance.

According to one embodiment, the photonic wafer comprises a plurality of second test assemblies each having a separation distance different from the other second assemblies.

According to one embodiment, the test device furthermore comprises at least one third test assembly, and the third test assembly is arranged such that the ends of said first and second test coupler of said third test assembly are offset along the Y axis by an associated lateral distance.

According to one embodiment, the photonic wafer comprises a plurality of third test assemblies each having an associated lateral distance different from the other third assemblies.

According to one embodiment, the test device furthermore comprises at least one fourth test assembly, and the fourth test assembly is arranged such that the waveguides and the ends of the first and second test coupler of the fourth assembly form an angle α1 and −α1, respectively, with the X axis.

According to one embodiment, the photonic wafer comprises a plurality of fourth test assemblies each having an angle α value different from the other fourth assemblies.

According to one embodiment, the first assembly, and where applicable the second, third and fourth assemblies, comprise a plurality of first and second test couplers arranged in series, the second test light/guide coupling device being connected to the last second test coupler.

According to another aspect, the invention relates to a method for testing a photonic wafer with a test device, the photonic wafer comprising at least one pattern, a pattern comprising at least one photonic chip, referred to as a functional photonic chip, and said test device, a functional photonic chip comprising photonic circuits comprising a plurality of functional edge couplers and functional waveguides, the photonic wafer comprising a substrate in an XY plane, a cladding layer and waveguides integrated into said cladding layer, the method comprising the following steps:
A measuring insertion losses, referred to as reference insertion losses, of a reference assembly comprising a reference waveguide and a first and second reference light/guide coupling device,
B measuring insertion losses, referred to as total insertion losses, of a first assembly, referred to as a test assembly, comprising:
   a first test edge coupler, called a first test coupler, comprising a first test waveguide and a first end,
   a first test light/guide coupling device,
   a second test edge coupler, called a second test coupler, comprising a second test waveguide and a second end,
   a second test light/guide coupling device,
   the first and second test coupler being identical,
   the first and second test coupler being arranged symmetrically about a point O, the first and second end facing one another and being separated by a first non-zero separation distance,
   the first and second test light/guide coupling devices and the first and second reference light/guide coupling devices all being identical.
C determining intrinsic insertion losses of the first and/or second test coupler based on the total insertion losses and the reference insertion losses.

According to one embodiment, said intrinsic insertion losses are determined in step C using the following formula, on a logarithmic scale:

IL_{EDC}=(ILₜₒₜ−IL_{ref})/2

with IL_{EDC} intrinsic insertion losses, ILₜₒₜ total insertion losses, and IL_{ref} reference insertion losses.

According to one embodiment, the first assembly comprises a plurality of 2N first and second test couplers arranged in series, the second test light/guide coupling device being connected to the last second test coupler, and said intrinsic insertion losses are determined in step C using the following formula, on a logarithmic scale:

IL_{EDC}=(ILₜₒₜ−IL_{ref})/2N
with IL_{EDC} intrinsic insertion losses, ILₜₒₜ total insertion losses, and IL_{ref} reference insertion losses.

According to another aspect, the invention relates to a method for fabricating at least one functional photonic chip, comprising:
a step of fabricating a photonic wafer according to one of the aspects of the invention, the at least one functional chip extending over what is referred to as a functional area, and the test device being arranged outside said functional area,
a step of implementing the method for testing said photonic wafer according to another aspect of the invention,
a step of slicing said at least one functional chip along a slice line that does not pass through the test device.

According to one embodiment, the step of fabricating the photonic wafer comprises a sub-step of etching trenches in a separation area between the first end and the second end of the first assembly of the test device, and a sub-step of etching trenches in said at least one functional chip for coupling with functional edge couplers, the two etching sub-steps being carried out with the same etching technology.

The following description presents a number of exemplary embodiments of the device of the invention: these examples do not limit the scope of the invention. These exemplary embodiments contain not only the features essential to the invention, but also additional features associated with the embodiments in question.

### BRIEF DESCRIPTION OF THE DRAWINGS

The invention will be better understood and other features, aims and advantages thereof will become apparent from the following detailed description, which is provided with reference to the appended drawings, which are given by way of non-limiting examples and in which:

FIG. 1, already cited, illustrates a photonic wafer having a trench allowing light/waveguide edge coupling.

FIG. 2, already cited, illustrates a characterization bench for characterizing an EDC-fiber system according to the prior art.

FIG. 3, already cited, illustrates a method for testing an assembly consisting of EDCs and fibers, allowing characterization on the scale of a whole wafer according to the prior art.

FIG. 4 illustrates a photonic wafer integrating a test device according to the invention.

FIG. 5 illustrates a variant of the invention in which the test device comprises trenches.

FIG. 6 illustrates one embodiment of the test device according to the invention without a trench, allowing the evaluation of an effect of moving the two ends apart/closer together along the X axis.

FIG. 7 illustrates one embodiment of the test device according to the invention with a trench, allowing the evaluation of an effect of moving the two ends apart/closer together along the X axis.

FIG. 8 illustrates one embodiment of the test device according to the invention without a trench, allowing the effect of a misalignment perpendicular to the X axis to be quantified.

FIG. 9 illustrates one embodiment of the test device according to the invention with a trench, allowing the effect of a misalignment perpendicular to the X axis to be quantified.

FIG. 10 illustrates one embodiment of the test device according to the invention without a trench, allowing the effect of an angular misalignment with respect to the X axis to be quantified.

FIG. 11 illustrates one embodiment of the test device according to the invention with a trench, allowing the effect of an angular misalignment with respect to the X axis to be quantified.

FIG. 12 illustrates one example of a combination of the embodiments illustrated in FIGS. 7, 9 and 11.

FIG. 13 illustrates one embodiment of the test device according to the invention in which a plurality of pairs of test couplers are arranged in series.

### DETAILED DESCRIPTION

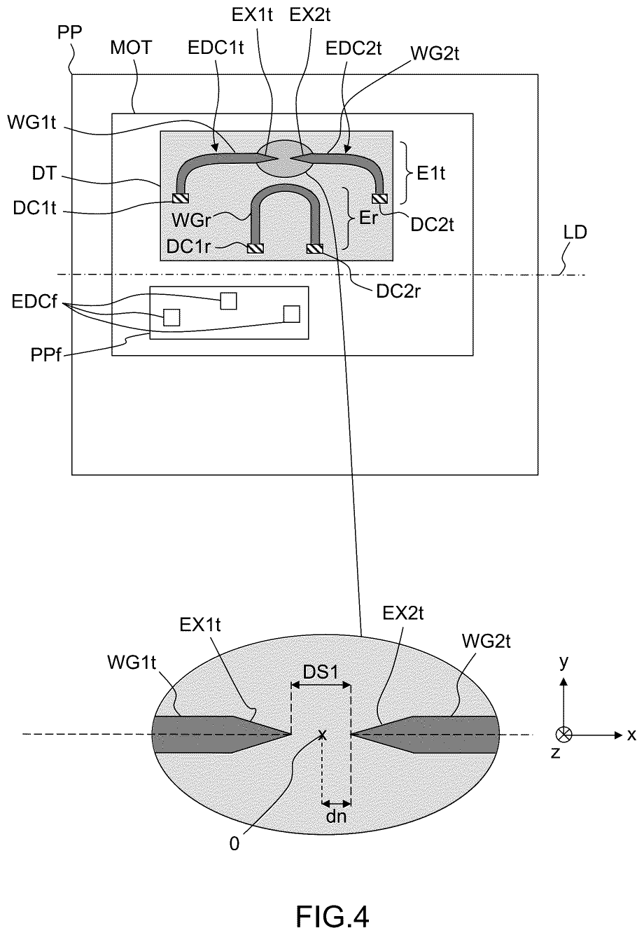

FIG. 4 depicts a photonic wafer PP according to the invention. The photonic wafer is the equivalent of an electronic wafer for circuit fabrication. It comprises at least one pattern MOT, a pattern comprising at least one photonic chip, referred to as a functional photonic chip PPf, and a test device DT. The complete wafer (also called “photonic wafer”) is typically fabricated by duplicating the pattern. Functional photonic chips PPf comprise a set of photonic circuits, a photonic circuit comprising at least one functional edge coupler EDCf and functional waveguides (WGf). A functional photonic chip may also comprise other photonic structures. The term “functional” is understood to mean elements intended to be used for the desired application of the chip or circuit. The test device is conventionally integrated into a test chip in which all test systems are concentrated.

Conventionally, the photonic wafer comprises a substrate SUB in an XY plane, a cladding layer CL and waveguides integrated into the cladding layer.

The couplers EDCf shown in FIG. 4 by way of example are “tapers”, but the test device (and the functional photonic chips) may comprise any type of EDC.

In addition to the functional elements, a pattern of the wafer comprises a test device DT comprising a first test assembly E1t and what is referred to as a reference assembly Er.

The first test assembly comprises a first test edge coupler EDC1t, called a first test coupler, comprising a first test waveguide WG1t and a first end EX1t, and a second test edge coupler EDC2t, called a second test coupler, comprising a second test waveguide WG2t and a second end EX2t.

The assembly ET1 also comprises a first test light/guide coupling device DC1t and a second test light/guide coupling device DC2t, respectively associated with WG1t and WG2t. A light/guide coupling device is understood to mean a coupler allowing light to be injected into or recovered from the associated waveguide. These test light/guide coupling devices may be of any type, vertical (grating) coupling or edge coupling.

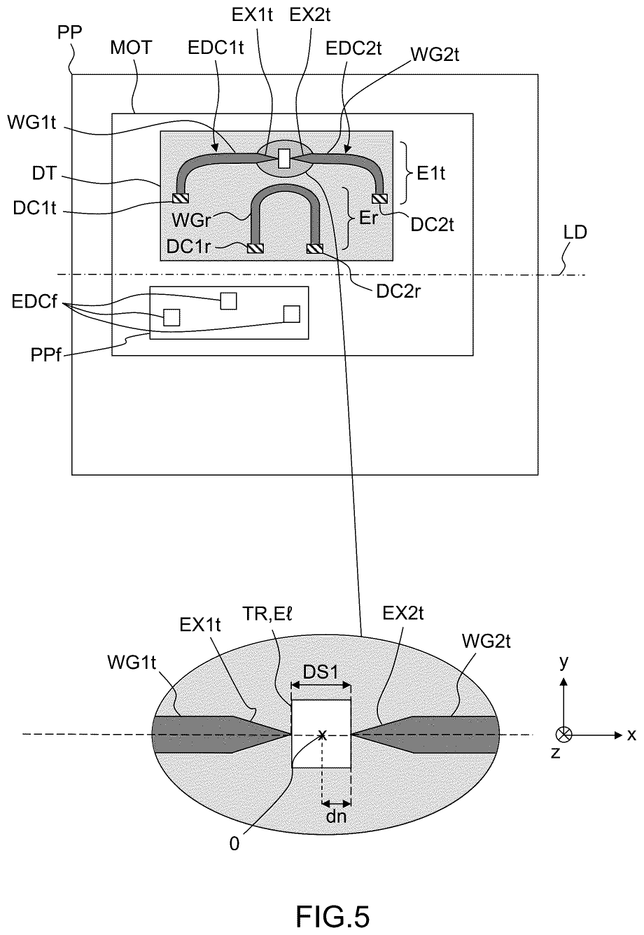

According to one embodiment, the first test assembly also comprises a first intermediate waveguide between the first light/guide coupling device DC1t and the first test waveguide WG1t, and the second test assembly also comprises a second intermediate waveguide between the second light/guide coupling device DC2t and the second test waveguide WG2t. This is preferably an extension of the waveguides WG1t/WG2t that may have non-rectilinear parts, for design convenience, as illustrated in FIGS. 4 and 5.

The first and second test coupler EDC1t and EDC2t are identical, that is to say they have an identical shape and are made of the same material.

Preferably, in order for the characterization carried out with the device DT to be as representative as possible, the test couplers EDC1t and EDC2t are identical to a functional edge coupler EDCf. The results of the test carried out based on EDC1t and EDC2t thus correspond to the performance of couplers present on the functional chips PPf.

The first and second test coupler EDC1t and EDC2t are arranged symmetrically about a point O, the first end EX1t and the second end EX2t facing one another and being separated by a first non-zero separation distance DS1, as illustrated in FIG. 4. The bottom of FIG. 4 corresponds to a zoom into the area around the two ends. The couplers EDC1t and EDC2t extend along an X axis, and the guides to which they are connected then evolve in the XY plane. The separation distance DS1 is chosen to represent twice the nominal use distance of a functional coupler, that is to say twice the distance between an optical fiber and a functional coupler.

The light injected for example by DC1t propagates in the first intermediate waveguide, when this exists, in EDC1t, first in the waveguide portion WG1t and then in the end EX1t, which is configured, as explained above, to match the mode of the light propagating in the guide, typically by broadening it. The light propagates in the intermediate area between the two ends, and is then coupled into the coupler EDC2t via the end EX2t, propagates in WG2t (and then in the second intermediate waveguide, when this exists), and is then extracted from the guide via DC2t. Thus, DC1t is used as light input and DC2t is used as output for the first test assembly E1t. No fiber is involved here on the path of the light between DC1t and DC2t.

The test device DT also comprises what is referred to as a reference assembly Er, comprising a reference waveguide WGr and a first reference light/guide coupling device DC1r and a second reference light/guide coupling device DC2r. DC1r is used as light input and DC2t is used as output in the reference assembly Er.

The light injected for example by DC1r propagates in WGr and is then recovered in DC2r.

To implement the test on the couplers EDC1t/EDC2t, the insertion losses IL_{ref}, referred to as reference insertion losses, of the reference assembly are measured, and the insertion losses, referred to as total insertion losses ILₜₒₜ, of the first test assembly E1t are measured. The intrinsic insertion losses IL_{EDC} of the first or second test coupler are then determined (these two couplers are identical, and preferably chosen to be identical to the functional couplers of the functional chip) based on the total insertion losses and the reference insertion losses.

The measurement is carried out with light having a wavelength used in the functional chip, for example λ=915 nm, 1310 nm or 1550 nm.

In order to be able to compare IL_{ref} and ILₜₒₜ, the first and second test light/guide coupling devices DC1t, DC2t and the first and second reference light/guide coupling devices DC1r, DC2r are all identical (same type, parameters, technology, etc.). For example, these four couplers are grating couplers.

The reference waveguide WGr typically has a cross section and a material identical to those of the waveguides WG1t/WG2t. Furthermore, when a first and a second intermediate waveguide are present in the test assembly E1t, the reference waveguide of the reference assembly also adopts the characteristics of these intermediate guides in its structure. The idea is that the reference waveguide WGr has a structure, in terms of cross section and material, that is close to and if possible equivalent to that of the waveguides of the test assembly. Preferably, the shape of WGr corresponds to that which the two waveguides of the test assembly would have if they were placed end to end, without the ends of EDC1t and EDC2t.

Thus, typically, the two assemblies E1t and Er consist of identical components, the only difference being the presence of the two ends of the test EDCs EDC1t and EDC2t separated by the distance DS1 for E1t. Since this is the same EDC twice, it is possible to calculate the intrinsic losses of a single test EDC using the following formula (on a logarithmic scale):

2×IL_{EDC}=ILₜₒₜ−IL_{ref}

That is to say:

IL_{EDC}=(ILₜₒₜ−IL_{ref})/2

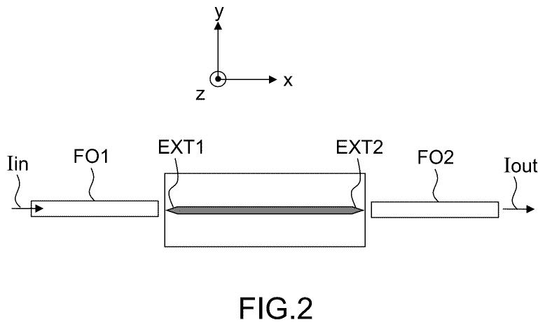

By integrating the test device on the wafer PP integrating the functional chips PPf, the wafer according to the invention is freed from undesirable contributions to the measurement of the losses of the test system of FIG. 2.

An EDC/fiber system is expected to have fewer losses than coupling a fiber to a grating coupler. However, in reality, many different contributions contribute to the total losses of a system as illustrated in FIG. 2: fiber alignment, medium between fiber and EDC, propagation in the EDC, linear and angular misalignment, fabrication errors, etc. Ideally, between 0 and 0.5 dB of losses are sought for the EDC/fiber system but, in concrete terms, up to 1.5 to 3 dB of losses are measured, i.e. much more than expected. In order to optimize the system, it is important to find out where the losses are coming from, and a total measurement on a system such as the one in FIG. 2 does not make it possible to obtain this information.

In the device DT according to the invention, rather than placing each EDC so as to face a fiber, the two (identical) test EDCs are placed facing one another, complying with a central symmetry, with the same EDC on both sides of the fixed point O. The solid connection between the two EDCs allows perfect and static positioning. The positioning is no longer disturbed by slight vibrations of the test bench.

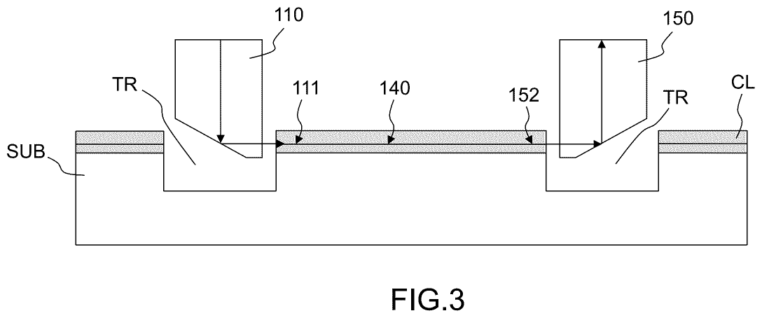

The test device DT integrated into the wafer PP according to the invention thus makes it possible to measure the intrinsic losses of an edge coupler, isolated from contributions from the other elements of the system, unlike the measurements carried out with known test devices illustrated in FIG. 2 or 3. This measurement of IL_{EDC} made possible by the device DT according to the invention concerns only the EDC, and is accurate and reliable.

Moreover, every integrated optics chip provider that uses EDCs as an interface has an interest in specifying their performance. The device DT integrated into a wafer or pattern allows precise characterization of the EDCs. It is integrated into all test systems installed on the wafer and makes it possible to verify the correct operation of the functional chips of the wafer.

According to one embodiment, the length L_{ref} of the reference waveguide is equal to the sum of the length of the waveguide between DC1t and EX1t and the length of the waveguide between DC2t and EX2t. The comparison between ILₜₒₜ and IL_{ref} then exhibits improved accuracy.

According to one embodiment, also illustrated in FIG. 4, the at least one functional chip PPf of the pattern MOT extends over what is referred to as a functional area, and the test device DT is arranged outside the functional area. This is made possible by the structure of the test device, which may be completely isolated from the circuits of the chip. The manufacturer who receives the wafer PP may thus, if necessary, carry out the tests with the circuit DT, and then separate the one or more chips by slicing, for example along a slice line LD illustrated in FIG. 4.

According to one embodiment, the first separation distance DS1 is equal to twice the nominal distance dn between the end of a functional edge coupler EDCf and an optical fiber with which the functional edge coupler is associated. The reproduction, by the test device according to the invention, of the real coupling situation in a functional chip is then improved.

According to one variant illustrated in FIG. 5, a trench TR has been etched in the separation area between the first end EX1t and the second end EX2t. The trench TR does not have a cladding layer CL, and may also be partially or totally dug into the substrate SUB. The trench may extend over the entire space between the two ends, or a small cladding thickness may be kept in contact with each of the ends. The latter case corresponds to the technological reality. Preferably, the etching technology used to produce the trench of the test device is identical to that with which the trenches are produced in the functional chips.

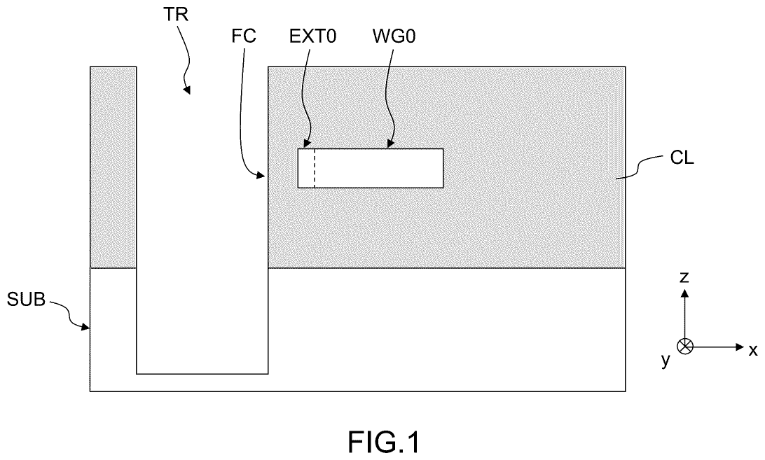

These deep trenches (100 μm is a typical value) are very commonly used to define the face of the EDC (see FIG. 1). Integrating a trench between the two EDCts creates a surface condition close to the real situation of a functional fiber/coupler coupling EDCf.

According to one embodiment, the trench TR is filled with an element El chosen from a solid material, a liquid, a gas or a vacuum. Preferably, the element El is identical to the one used for the functional trenches allowing the coupling of a functional edge coupler EDCf of a functional chip PPf of the wafer PP with an associated optical fiber.

Integrating a trench between the two test EDCs thus makes it possible to extract the intrinsic performance of an EDC in real use conditions, and preferably of a functional EDC in real use conditions, in the case where test EDCs identical to the functional EDCs have been chosen.

According to one embodiment, the material of the trench is an index liquid or a glue.

By way of example, the substrate of the wafer PP is made of silicon, the cladding layer CL is made of silicon oxide SiO₂ and the waveguides are made of silicon Si or silicon nitride SiₓN_{y}.

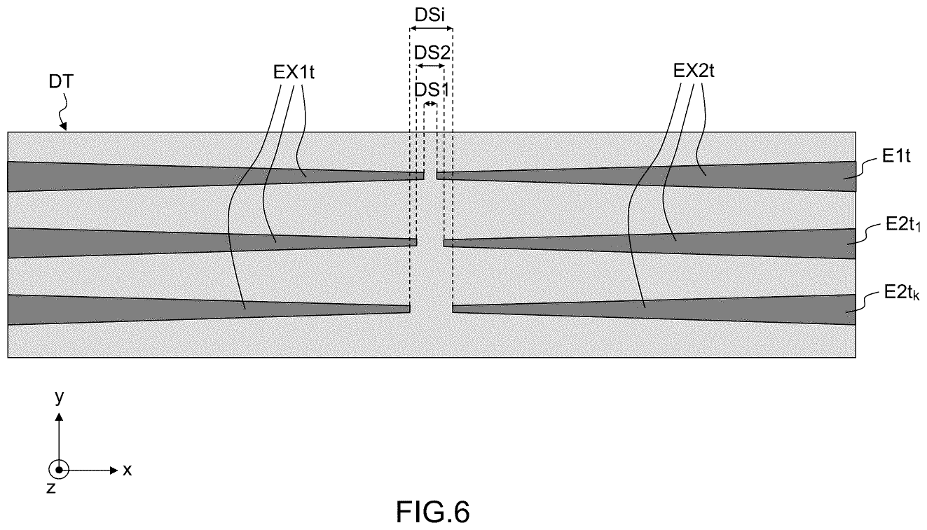

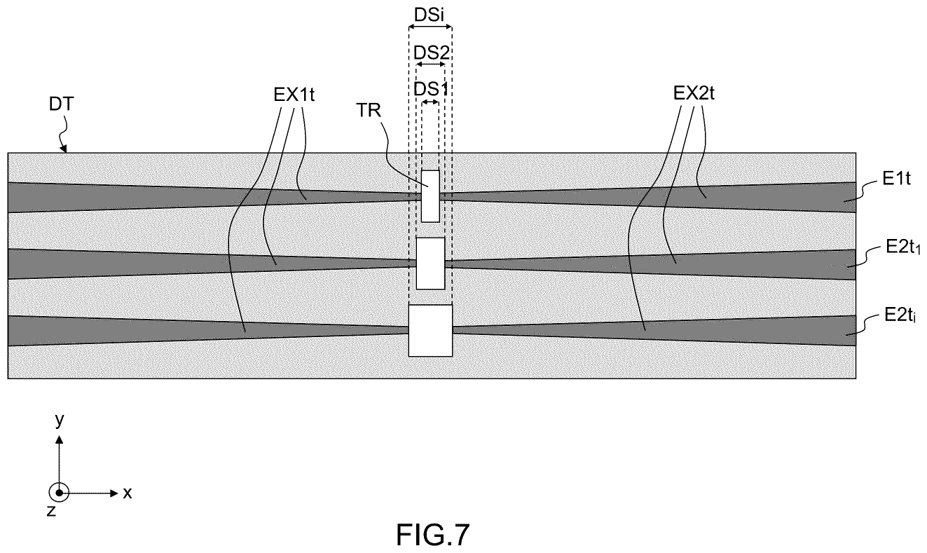

According to one embodiment of the invention, applicable to the test device without or with a trench, the test device DT comprises at least one second test assembly E2t1 having a second separation distance DS2 different from the first separation distance, as illustrated in FIG. 6 for the test device without a trench and FIG. 7 for the variant of the test device with a trench.

The separation distance DS2 may be zero (applicable to the variant without a trench), thereby making it possible to measure the performance of the coupler in a configuration where the two ends touch one another.

According to one embodiment, the device DT comprises a plurality of second test assemblies E2ti indexed i, with i varying from 1 to n, each having a separation distance DSi different from the other second assemblies.

By way of example, for the embodiment of FIG. 6, assemblies (E1t and E2ti) with separation distances of 0.5, 2.5, 5, 7.5 and 10 μm are produced.

Measuring the associated intrinsic losses IL_{EDC}(i) makes it possible to quantify the effect of moving the two ends apart/closer together along the X axis, with respect to the “reference” distance DS1 of the first assembly.

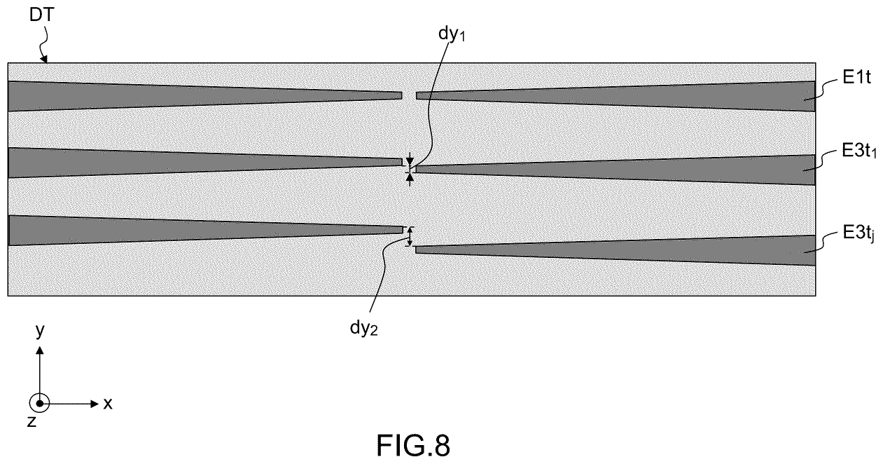

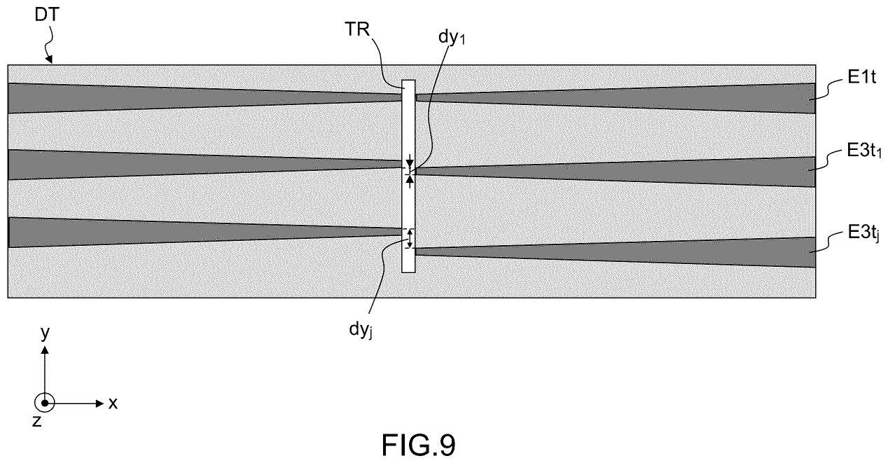

According to one embodiment of the invention, applicable to the test device without or with a trench, the test device DT comprises at least one third test assembly E3t1, the third test assembly being arranged such that the ends of the first and second test couplers of the third test assembly are offset along the Y axis by an associated lateral distance dy₁. This embodiment is illustrated in FIG. 8 for the test device without a trench and in FIG. 9 for the variant of the test device with a trench.

For the embodiment of FIG. 9, according to one option, the various assemblies share one and the same trench, as illustrated in FIG. 9.

According to one embodiment, as illustrated in FIGS. 8 and 9, the device DT comprises a plurality of third test assemblies E3tⱼ indexed j, with j varying from 1 to m, each having an associated lateral distance dyⱼ different from the other third assemblies.

Measuring the associated intrinsic losses IL_{EDC}(j) makes it possible to quantify the effect of a misalignment perpendicular to the X axis, with respect to the configuration of the first assembly E1t aligned along X.

The test device illustrated in FIG. 8 or 9, and the associated measurements IL_{EDC}(j) as a function of dyⱼ, also makes it possible to quantify the diameter of the mode, called MFD for mode field diameter. This parameter is very useful for choosing a fiber with an appropriate core, that is to say with a similar MFD, in order to reduce EDC/fiber coupling losses.

By way of example, for the embodiment of FIG. 8, assemblies (E1t and E3tj) with lateral offsets of 0, 0.5, 1, 2, 3 and 5μm are produced.

According to one embodiment of the invention, applicable to the test device without or with a trench, the test device DT comprises at least one fourth test assembly E4t₁, the fourth test assembly being arranged such that the waveguides and the ends of the first and second test coupler of the fourth assembly form an angle α1 and −α1, respectively, with the X axis. The first and second test couplers of the fourth assembly are then no longer arranged symmetrically to the point O, and both no longer extend along the X axis.

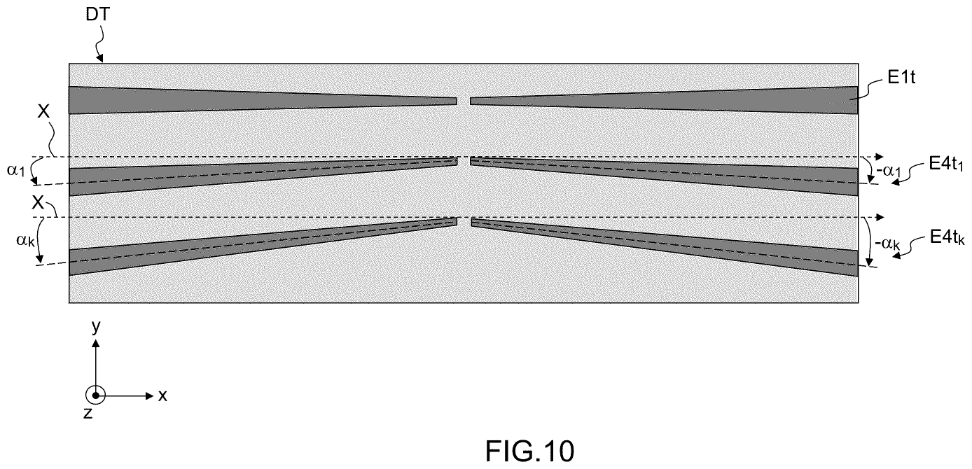

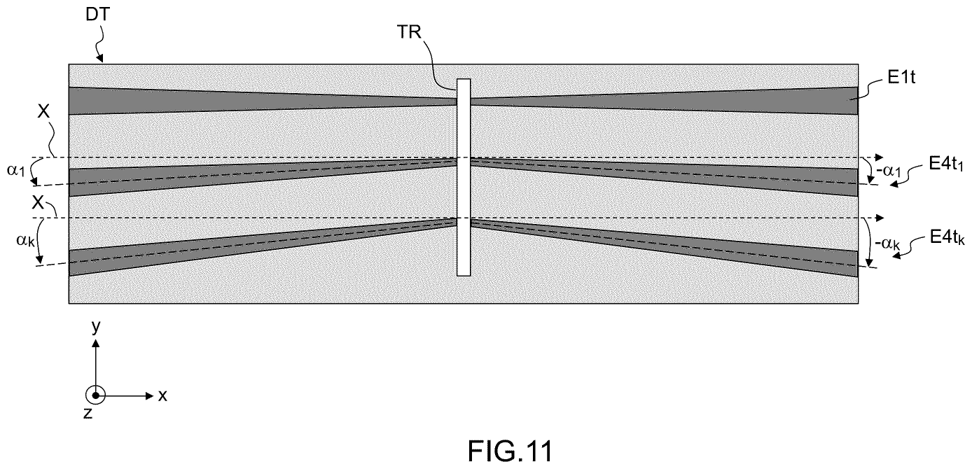

This embodiment is illustrated in FIG. 10 for the test device without a trench and in FIG. 11 for the variant of the test device with a trench.

For the embodiment of FIG. 11, according to one option, the various assemblies share one and the same trench, as illustrated in FIG. 11.

According to one embodiment, as illustrated in FIGS. 10 and 11, the device DT comprises a plurality of fourth test assemblies E4tk indexed k, with k varying from 1 to l, each having an angle αk value different from the other fourth assemblies.

Measuring the associated intrinsic losses IL_{EDC}(k) makes it possible to quantify the effect of an angular misalignment with respect to the X axis, with respect to the configuration of the first assembly E1t aligned along X.

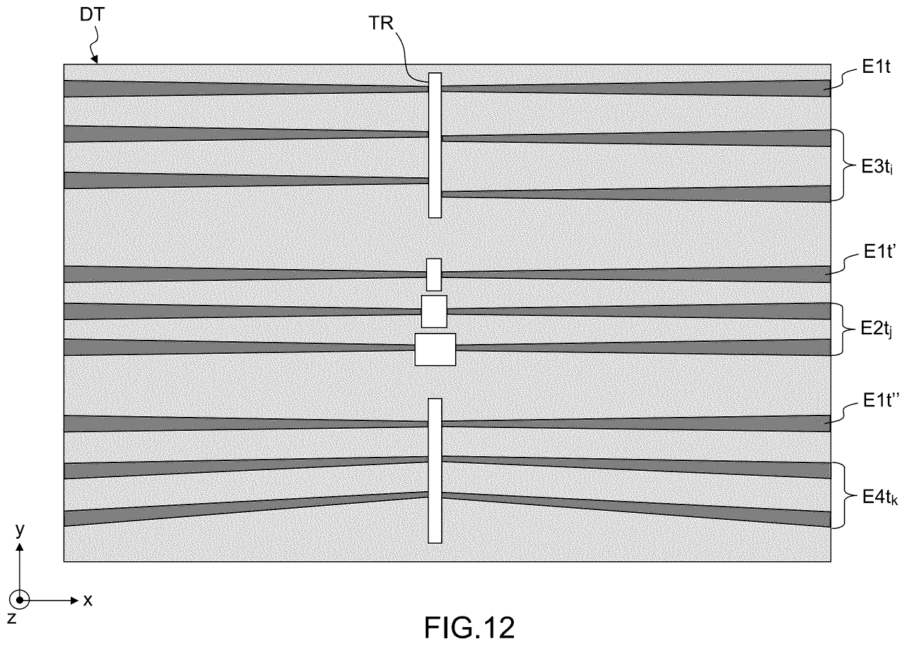

The various embodiments illustrated in FIGS. 6 to 11 may of course be combined with one another. By way of example, FIG. 12 illustrates the combination of the embodiments of FIGS. 7, 9 and 11, with the option of a plurality of first assemblies E1t. According to another option, the device DT comprises only one first assembly E1t, associated with multiple second and/or third and/or fourth assemblies, without and/or with trenches.

For the embodiments illustrated in FIGS. 6 to 12, the reference assembly Er has not been shown.

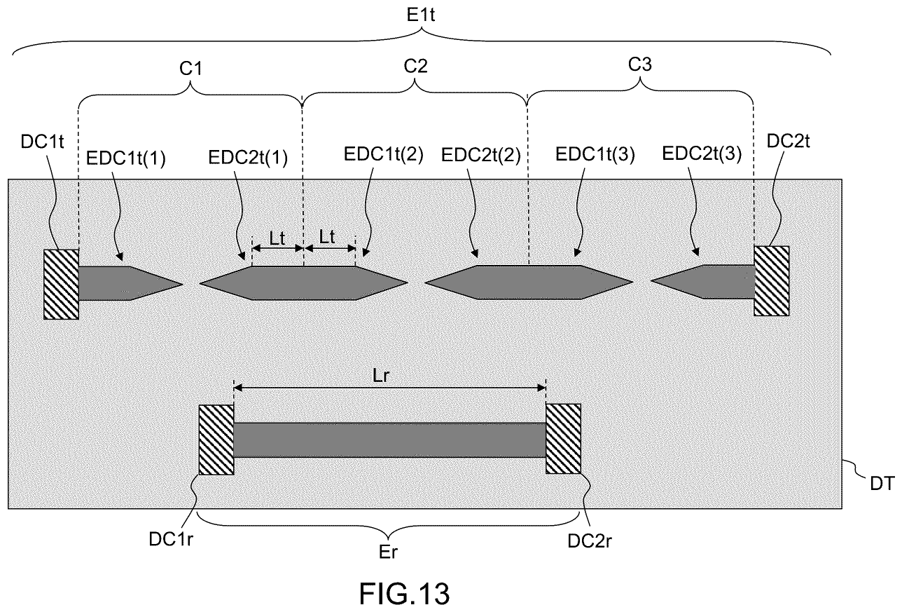

According to one embodiment illustrated in FIG. 13, the first assembly E1t comprises a plurality of first and second test couplers arranged in series, the second test light/guide coupling device DC2t being connected to the last second test coupler. This thus gives N total number of pairs (EDC1t, EDC2t). FIG. 13 illustrates N=3 pairs (EDC1t, EDC2t), identified as pairs Cm (EDC1t(m), EDC2t(m)), with m the number of the pair, ranging from 1 to 3. This embodiment is of course also applicable to the second, third and fourth assemblies.

Let Lt be the length of the waveguide between the light/guide coupling device and the associated end of each of the identical test couplers, and L_{ref} be the length of the reference waveguide.

Preferably:

L_{ref}=2N.Lt

According to another aspect, the invention relates to a method 100 for testing a photonic wafer PP with a test device DT as described above.

In a first step A, insertion losses IL_{ref}, referred to as reference insertion losses, of the reference assembly Er are measured. In a second step B, the insertion losses, referred to as total insertion losses ILₜₒₜ, of the first test assembly E1t are measured. The timing of the two steps A and B may of course be swapped. Insertion losses are typically measured based on input and output intensity measurements. It is typically sufficient to measure only the output intensities. By using the same measurement system, the same losses are added to IL_{ref} and ILₜₒₜ, and therefore do not modify the difference ILₜₒₜ-IL_{ref}.

Finally, in a step C, the intrinsic insertion losses IL_{EDC} of the first and/or second test coupler (these are identical) are determined based on the total insertion losses and the reference insertion losses.

Preferably, the intrinsic insertion losses IL_{EDC} of an EDCt are determined using the following formula, on a logarithmic scale (for a pair (EDC1t, EDC2t)):

IL_{EDC}=(ILₜₒₜ−IL_{ref})/2

For the embodiment with N pairs of test couplers in series, the formula becomes:

IL_{EDC}=(ILₜₒₜ−IL_{ref})/(2×N)

The test method 100 is a systematic test on EDCs following fabrication of the wafer.

For photonic wafer manufacturers, it is attractive to display the intrinsic performance and to use the IL_{EDC} measurements carried out in accordance with the method 100 in order to quantify IL_{EDC} of their EDCs. Indeed, intrinsic performance is generally better than the performance of the system. Intrinsic performance IL_{EDC} for example comes under specifications issued by the wafer manufacturer or by a chip vendor.

According to yet another aspect, the invention relates to a method for fabricating at least one functional photonic chip PPf.

In a (first) step, a photonic wafer PP as described above is fabricated, integrating the test device DT. The methods for fabricating such a wafer are known to those skilled in the art. The wafer is arranged such that the at least one functional chip PPf extends over what is referred to as a functional area, and the test device DT being arranged outside the functional area. This arrangement is made possible because the test device is independent of the circuits of the functional chip.

Next, in one step, the test method 100 is implemented.

In another step, the at least one functional chip PPf is sliced along a slice line LD (see FIGS. 4 and 5) that does not pass through the test device. This is made possible because the test device is located outside the functional area. The slicing step may be implemented before or after the step of implementing the test method.

According to one embodiment, the step of fabricating the photonic wafer PP comprises a sub-step of etching trenches in the separation area between the first end and the second end of the first assembly of the test device DT, and a sub-step of etching trenches in the at least one functional chip for coupling with functional edge couplers EDCf. The two etching sub-steps, to free up the EDCts and the EDCfs, are carried out with the same etching technology.

The test device DT, and the associated test method 100, are thus representative of the real coupling conditions in the functional chip.

Preferably, the two etching sub-steps form only one step, the etching being carried out in parallel, simultaneously over the entire pattern or even over the entire wafer.

1. A photonic wafer (PP) comprising at least one pattern (MOT), a pattern comprising at least one photonic chip, being a functional photonic chip (PPf), and a test device (DT), the functional photonic chip of said pattern comprising photonic circuits comprising at least one functional edge coupler (EDCf) and functional waveguides (WGf),
the photonic wafer comprising a substrate (SUB) in an XY plane, a cladding layer (CL) and waveguides integrated into said cladding layer,
the test device (DT) of said pattern comprising:
a first test assembly (E1t) comprising:
a first test edge coupler (EDC1t), called a first test coupler, comprising
a first test waveguide (WG1t) and a first end (EX1t),
a first test light/guide coupling device (DC1t),
a second test edge coupler (EDC2t), called a second test coupler,
comprising a second test waveguide (WG2t) and a second end (EX2t),
a second test light/guide coupling device (DC2t),
the first and second test coupler being identical,
the first and second test coupler being arranged symmetrically about a point O, the first and second end facing one another and being
separated by a first non-zero separation distance (DS1),
an assembly, being a reference assembly (Er), comprising a reference waveguide (WGr) and a first and second reference light/guide coupling device (DC1r, DC2r),
the first and second test light/guide coupling devices (DC1t, DC2t) and the first and second reference light/guide coupling devices (DC1r, DC2r) all being identical.

2. The photonic wafer as claimed in claim 1, wherein the functional chip extends over a functional area, and the test device (DT) is arranged outside said functional area.

3. The photonic wafer as claimed in claim 1, wherein the first separation distance (DS1) is equal to twice a nominal distance (dn) between one end of a functional edge coupler (EDCf) and an optical fiber with which said functional edge coupler is associated.

4. The photonic wafer as claimed in claim 1, wherein a trench (TR) has been etched in a separation area between the first end and the second end.

5. The photonic wafer as claimed in claim 4, wherein the trench is filled with an element (El) chosen from a solid material, a liquid, a gas or a vacuum.

6. The photonic wafer as claimed in claim 1, wherein the substrate is made of silicon, the cladding layer is made of silicon oxide (SiO₂) and the waveguides are made of silicon (Si) or silicon nitride (SiₓN_{y}).

7. The photonic wafer as claimed in claim 1, wherein the test device furthermore comprises at least one second test assembly (E2t₁) having a second separation distance (DS2) different from the first separation distance.

8. The photonic wafer as claimed in claim 7, comprising a plurality of second test assemblies (E2tᵢ) each having a separation distance (DSi) different from the other second assemblies.

9. The photonic wafer as claimed in claim 1, wherein the test device furthermore comprises at least one third test assembly (E3t₁), and wherein the third test assembly is arranged such that the ends of said first and second test coupler of said third test assembly are offset along the Y axis by an associated lateral distance (dy₁).

10. The photonic wafer as claimed in claim 9, comprising a plurality of third test assemblies (E3tⱼ) each having an associated lateral distance (dyⱼ) different from the other third assemblies.

11. The photonic wafer as claimed in claim 1, wherein the test device furthermore comprises at least one fourth test assembly (E4t₁), and wherein the fourth test assembly is arranged such that the waveguides and the ends of the first and second test coupler of the fourth assembly form an angle α1 and −α1, respectively, with the X axis.

12. The photonic wafer as claimed in claim 11, comprising a plurality of fourth test assemblies (E4tk) each having an angle α value (αk) different from the other fourth assemblies.

13. The photonic wafer as claimed in claim 1, wherein the first assembly, and where applicable the second, third and fourth assemblies, comprise a plurality of first and second test couplers arranged in series, the second test light/guide coupling device (DC2t) being connected to the last second test coupler.

14. A method for testing a photonic wafer (PP) with a test device (DT),
the photonic wafer comprising at least one pattern (MOT), a pattern comprising at least one photonic chip, being a functional photonic chip (PPf), and said test device (DT),
the functional photonic chip of said pattern comprising photonic circuits comprising a plurality of functional edge couplers (EDCf) and functional waveguides (WGf),
the photonic wafer comprising a substrate (SUB) in an XY plane, a cladding layer (CL) and waveguides (WG) integrated into said cladding layer,
the method comprising the following steps:
A measuring insertion losses (IL_{ref}), being reference insertion losses, of a reference assembly comprising a reference waveguide (WGr) and a first and second reference light/guide coupling device (DC1r, DC2r),
B measuring insertion losses, being total insertion losses (ILₜₒₜ), of a first assembly, being a test assembly (E1t), comprising:
a first test edge coupler (EDC1t), called a first test coupler, comprising
a first test waveguide (WG1t) and a first end (EX1t),
a first test light/guide coupling device (DC1t),
a second test edge coupler (EDC2t), called a second test coupler,
comprising a second test waveguide (WG2t) and a second end (EX2t),
a second test light/guide coupling device (DC2t),
the first and second test coupler being identical,
the first and second test coupler being arranged symmetrically about a point O, the first and second end facing one another and being separated by a first non-zero separation distance (DS1),
the first and second test light/guide coupling devices (DC1t, DC2t) and the first and second reference light/guide coupling devices (DC1r, DC2r) all being identical,
C determining intrinsic insertion losses (IL_{EDC}) of the first and/or second test coupler based on the total insertion losses and the reference insertion losses.

15. The method as claimed in claim 14, wherein said intrinsic insertion losses are determined in step C using the following formula, on a logarithmic scale:
IL_{EDC}=(ILₜₒₜ−IL_{ref})/2
with IL_{EDC} intrinsic insertion losses, ILₜₒₜ total insertion losses, and IL_{ref} reference insertion losses.

16. The method as claimed in claim 14, wherein the first assembly comprises a plurality of 2N first and second test couplers arranged in series, the second test light/guide coupling device (DC2t) being connected to the last second test coupler, and wherein said intrinsic insertion losses are determined in step C using the following formula, on a logarithmic scale:
IL_{EDC}=(ILₜₒₜ−IL_{ref})/2N
with IL_{EDC} intrinsic insertion losses, ILₜₒₜ total insertion losses, and IL_{ref} reference insertion losses.

17. A method for fabricating at least one functional photonic chip (PPf), comprising:
a step of fabricating a photonic wafer (PP) comprising at least one pattern (MOT), a pattern comprising at least one photonic chip, being a functional photonic chip (PPf), and a test device (DT), the functional photonic chip of said pattern comprising photonic circuits comprising at least one functional edge coupler (EDCf) and functional waveguides (WGf), the photonic wafer comprising a substrate (SUB) in an XY plane, a cladding layer (CL) and waveguides integrated into said cladding layer,
the test device (DT) of said pattern comprising
a first test assembly (E1t) comprising:
a first test edge coupler (EDC1t), called a first test coupler,
comprising a first test waveguide (WG1t) and a first end (EX1t),
a first test light/guide coupling device (DC1t),
a second test edge coupler (EDC2t), called a second test coupler, comprising a second test waveguide (WG2t) and a second end (EX2t),
a second test light/guide coupling device (DC2t),
the first and second test coupler being identical,
the first and second test coupler being arranged symmetrically about a point O, the first and second end facing one another and being separated by a first non-zero separation distance (DS1),
an assembly, being a reference assembly (Er), comprising a reference waveguide (WGr) and a first and second reference light/guide coupling device (DC1r, DC2r),
the first and second test light/guide coupling devices (DC1t, DC2t) and the first and second reference light/guide coupling devices (DC1r, DC2r) all being identical, the at least one functional chip extending over a functional area, and the test device (DT) being arranged outside said functional area;
a step of implementing the method for testing said photonic wafer as claimed in claim 14,
a step of slicing said at least one functional chip along a slice line (LD) that does not pass through the test device.

18. The method as claimed in the claim 17, wherein the step of fabricating the photonic wafer comprises a sub-step of etching trenches in a separation area between the first end and the second end of the first assembly of the test device, and a sub-step of etching trenches in said at least one functional chip for coupling with functional edge couplers, the two etching sub-steps being carried out with the same etching technology.
